(19) United States
(12) Patent Application Publication
(10) Pub. No.: US 2022/0041139 A1
(43) Pub. Date: Feb. 10, 2022

(54) SENSOR CLEANING APPARATUS

(71) Applicant: Ford Global Technologies, LLC, Dearborn, MI (US)

(72) Inventors: Raghuraman Surineedi, Dearborn, MI (US); Kunal Singh, Farmington Hills, MI (US); Ashwin Arunmozhi, Canton, MI (US); Venkatesh Krishnan, Canton, MI (US); Michael Robertson, JR., Garden City, MI (US); Rashaun Phinisee, Ypsilanti, MI (US)

(73) Assignee: Ford Global Technologies, LLC, Dearborn, MI (US)

(21) Appl. No.: 16/985,299

(22) Filed: Aug. 5, 2020

(51) Int. Cl. B60S 1/62; B60R 11/00

(52) U.S. Cl. CPC B60S 1/62; B60R 2011/004; B60R 11/00

(57) ABSTRACT

A sensor apparatus includes a cylindrical sensor window defining an axis, and a plurality of at least three tubular segments fixed relative to the sensor window. Each tubular segment is elongated circumferentially relative to the axis. The tubular segments collectively form a ring substantially centered around the axis. Each tubular segment includes a plurality of nozzles. Each nozzle includes a first opening and a second opening. Each of the first openings has a direction of discharge in a radially inward and axial direction forming a first angle with the axis, and each of the second openings has a direction of discharge in a radially inward and axial direction forming a second angle with the axis. The second angle is different than the first angle.

### BACKGROUND

Autonomous vehicles typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. When sensor lenses, covers, and the like become dirty, smudged, etc., sensor operation can be impaired or precluded.

### BRIEF DESCRIPTION OF THE DRAWINGS

FIG. 1 is a perspective view of an example vehicle.

FIG. 2 is an exploded perspective view of a sensor apparatus of the vehicle.

FIG. 3 is a perspective view of a portion of the sensor apparatus.

FIG. 4 is a diagram of an example sensor-cleaning system of the vehicle.

FIG. 5 is a cross-sectional perspective view of a portion of the sensor apparatus.

FIG. 6 is an exploded view of tubular segments of the sensor apparatus.

FIG. 7 is a top view of a portion of the sensor apparatus.

FIG. 8 is a cross-sectional view of a nozzle including example first and second openings.

FIG. 9 is a perspective view of a portion of the sensor apparatus including example spray patterns from the exemplary first and second openings.

FIG. 10 is a cross-sectional perspective view of a portion of the sensor assembly.

FIG. 11 is a block diagram of an example control system for the sensor assembly.

FIG. 12 is a process flow diagram of an example process for controlling the sensor assembly.

### DETAILED DESCRIPTION

A sensor apparatus includes a cylindrical sensor window defining an axis and a plurality of at least three tubular segments fixed relative to the sensor window. Each tubular segment is elongated circumferentially relative to the axis. The tubular segments collectively form a ring substantially centered around the axis. Each tubular segment includes a plurality of nozzles. Each nozzle includes a first opening and a second opening. Each of the first openings has a direction of discharge in a radially inward and axial direction forming a first angle with the axis. Each of the second openings has a direction of discharge in a radially inward and axial direction forming a second angle with the axis. The second angle is different than the first angle.

Each nozzle may be elongated along the axis. The first opening may be spaced from the second opening along the axis.

The plurality of nozzles may be substantially evenly spaced around the ring.

The first and second openings may be shaped to spray fluid in a full cone pattern.

Each nozzle may define a nozzle axis extending parallel to the axis. The first and second openings may be aligned circumferentially around the nozzle axis.

Each nozzle may include a wall defining a nozzle cavity. The first and second openings each may include an upper surface extending through the wall to the nozzle cavity and a lower surface extending transverse to the upper surface and through the wall to the nozzle cavity.

The upper surface of each first opening may be oblique to the axis. The upper surface of each second opening may be oblique to the axis.

The upper and lower surfaces of each first opening may define the first angle with the axis. The upper and lower surfaces of each second opening may define the second angle with the axis.

The upper surface of each first opening may extend transverse to the respective lower surface of the respective second opening.

The first and second openings may be concurrently in fluid communication with the nozzle cavity.

The sensor window may include a first half and a second half. The first half and the second half of the sensor window may encompass all of the sensor window and may be nonoverlapping. The first half may be farther from the nozzles along the axis than the second half. The direction of discharge of the first opening may intersect the first half of the sensor window, and the direction of discharge of the second opening may intersect the second half of the sensor window.

The first opening may be shaped to emit a spray pattern extending along the first half of the sensor window to the second half of the sensor window. The second opening may be shaped to emit a spray pattern extending along the second half of the sensor window to the first half of the sensor window.

Each nozzle may define a nozzle axis extending parallel to the axis. The first and second openings each may be shaped to emit a spray pattern having a spray angle measured circumferentially about the respective nozzle axis. The spray angle of the second opening may be different than the spray angle of the first opening.

Each tubular segment may be fluidly isolated from the other tubular segments.

The sensor apparatus may further include a reservoir fluidly coupled to each tubular segment and a plurality of valves. Each valve may be actuatable to permit or block flow from the reservoir to a respective one of the tubular segments.

Each tubular segment may include a lower piece and an upper piece, each lower piece may define a channel extending circumferentially around the axis, and each upper piece may enclose the channel.

The upper pieces may include the nozzles.

Each upper piece may be monolithic.

The lower pieces each may include an inlet.

The lower pieces may be collectively a single piece that is monolithic.

With reference to the Figures, wherein like numerals indicate like parts throughout the several views, a sensor apparatus 12 for a vehicle 10 includes a cylindrical sensor window 14 defining an axis A, and a plurality of at least three tubular segments 16 fixed relative to the sensor window 14. Each tubular segment 16 is elongated circumferentially relative to the axis A. The tubular segments 16 collectively form a ring 18 substantially centered around the axis A. Each tubular segment 16 includes a plurality of nozzles 20. Each nozzle 20 includes a first opening 22 and a second opening 24. Each of the first openings 22 has a direction of discharge in a radially inward and axial direction forming a first angle θ with the axis A, and each of the second openings 24 has a direction of discharge in a radially inward and axial direction forming a second angle φ with the axis A. The second angle φ is different than the first angle θ.

The sensor apparatus 12 uses fluid for cleaning the sensor window 14, which can improve the quality of data gathered by a sensor 26 behind the sensor window 14. The sensor apparatus 12 has a robust design without moving parts for distributing fluid from the nozzles 20; i.e., the tubular segments 16, including the nozzles 20, have no moving parts. The sensor window 14 has a height along the axis A, and the sensor 26 can gather data along the full height of the sensor window 14. The first and second openings 22, 24 of each nozzle 20 direct fluid at the different first angle θ and second angle φ to provide coverage along the full height of the sensor window 14. Additionally, the nozzles 20 are arranged around the sensor window 14 to provide coverage that approximates the cylindrical shape of the sensor window 14, thus making efficient use of the fluid by reducing the amount of washer fluid overspray, i.e., overlap of spray patterns, from adjacent nozzles 20.

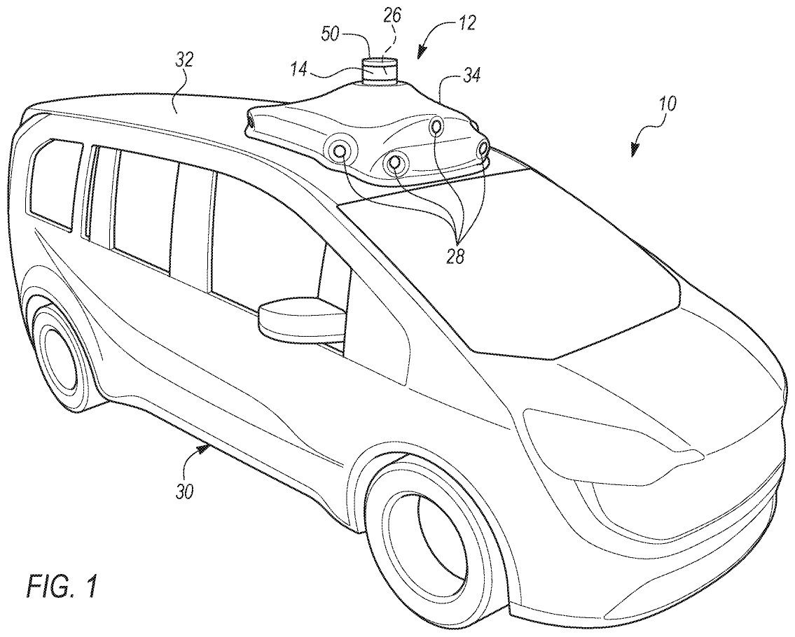

With reference to FIG. 1, the vehicle 10 may be any passenger or commercial automobile such as a car, a truck, a sport utility vehicle, a crossover, a van, a minivan, a taxi, a bus, etc.

The vehicle 10 may be an autonomous vehicle. A vehicle computer can be programmed to operate the vehicle 10 independently of the intervention of a human driver, completely or to a lesser degree. The vehicle computer may be programmed to operate a propulsion, brake system, steering, and/or other vehicle systems based at least in part on data received from the sensor 26 described below, as well as other sensors 28. For the purposes of this disclosure, autonomous operation means the vehicle computer controls the propulsion, brake system, and steering without input from a human driver; semi-autonomous operation means the vehicle computer controls one or two of the propulsion, brake system, and steering and a human driver controls the remainder; and nonautonomous operation means a human driver controls the propulsion, brake system, and steering.

The vehicle 10 includes a body 30. The vehicle 10 may be of a unibody construction, in which a frame and the body 30 of the vehicle 10 are a single component. The vehicle 10 may, alternatively, be of a body-on-frame construction, in which the frame supports the body 30 that is a separate component from the frame. The frame and body 30 may be formed of any suitable material, for example, steel, aluminum, etc.

The body 30 includes body panels 32 partially defining an exterior of the vehicle 10. The body panels 32 may present a class-A surface, e.g., a finished surface exposed to view by a customer and free of unaesthetic blemishes and defects. The body panels 32 include, e.g., a roof, etc.

The sensor apparatus 12 includes a housing 34 for the sensor 26 and the other sensors 28. The housing 34 is attachable to the vehicle 10, e.g., to one of the body panels 32 of the vehicle 10, e.g., the roof. For example, the housing 34 may be shaped to be attachable to the roof, e.g., may have a shape matching a contour of the roof. The housing 34 may be attached to the roof, which can provide the sensor 26 and the other sensors 28 with an unobstructed field of view of an area around the vehicle 10. The housing 34 may be formed of, e.g., plastic or metal.

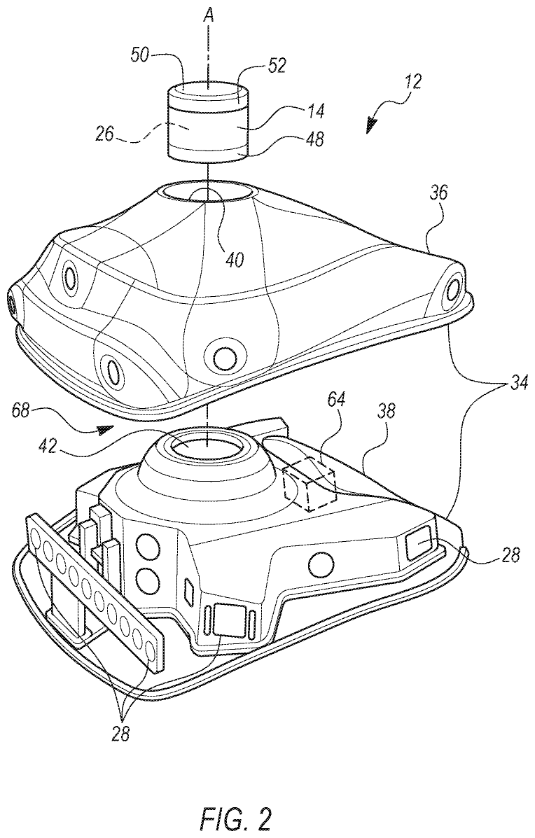

With reference to FIG. 2, the housing 34 includes a housing upper piece 36 and a housing lower piece 38. The housing upper piece 36 and the housing lower piece 38 are shaped to fit together, with the housing upper piece 36 fitting on top of the housing lower piece 38. The housing upper piece 36 covers the housing lower piece 38. The housing upper piece 36 includes a central opening 40 that exposes the housing lower piece 38. The central opening 40 is round, e.g., has a circular or slightly elliptical shape. The housing upper piece 36 and the housing lower piece 38 are each monolithic. For the purposes of this disclosure, “monolithic” means a single-piece unit, i.e., a continuous piece of material without any fasteners, joints, welding, adhesives, etc., fixing multiple pieces to each other. For example, the housing upper piece 36 and the housing lower piece 38 may each be stamped or molded as a single piece. The housing lower piece 38 includes a bracket 42, a supporting panel 44 (described below), and a drainage channel 46 (described below), so the bracket 42, the supporting panel 44, and the drainage channel 46 are together a single piece.

The housing lower piece 38 includes the bracket 42 to which a sensor-housing bottom portion 48 of a sensor housing 50 is mounted. The sensor housing 50 is supported by and mounted to the housing 34, specifically the housing lower piece 38. The sensor housing 50 can be disposed on top of the housing 34 at a highest point of the housing 34. The bracket 42 is shaped to accept and fix in place the sensor-housing bottom portion 48 of the sensor housing 50, e.g., with a press fit or snap fit. The bracket 42 defines an orientation and position of the sensor housing 50 relative to the vehicle 10.

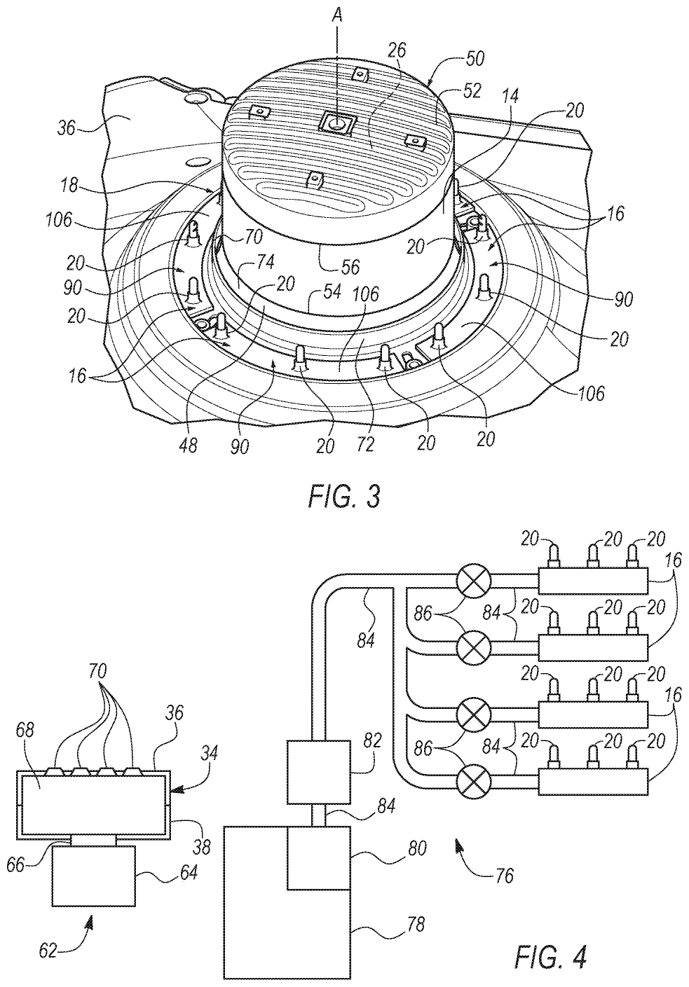

With reference to FIG. 3, the sensor housing 50 has a cylindrical shape and defines an axis A. The sensor housing 50 extends vertically upward along the axis A from the sensor-housing bottom 48. The sensor housing 50 includes a sensor-housing top 52, the sensor window 14, and the sensor-housing bottom 48. The sensor-housing top 52 is disposed directly above the sensor window 14, and the sensor-housing bottom 48 is disposed directly below the sensor window 14. The sensor-housing top 52 and the sensor-housing bottom 48 are vertically spaced apart by a height of the sensor window 14.

The sensor 26 is disposed inside the sensor housing 50 and is attached to and supported by the housing 34. The sensor 26 may be designed to detect features of the outside world; for example, the sensor 26 may be a radar sensor, a scanning laser range finder, a light detection and ranging (LIDAR) device, or an image processing sensor such as a camera. In particular, the sensor 26 may be a LIDAR device, e.g., a scanning LIDAR device. A LIDAR device detects distances to objects by emitting laser pulses at a particular wavelength and measuring the time of flight for the pulse to travel to the object and back.

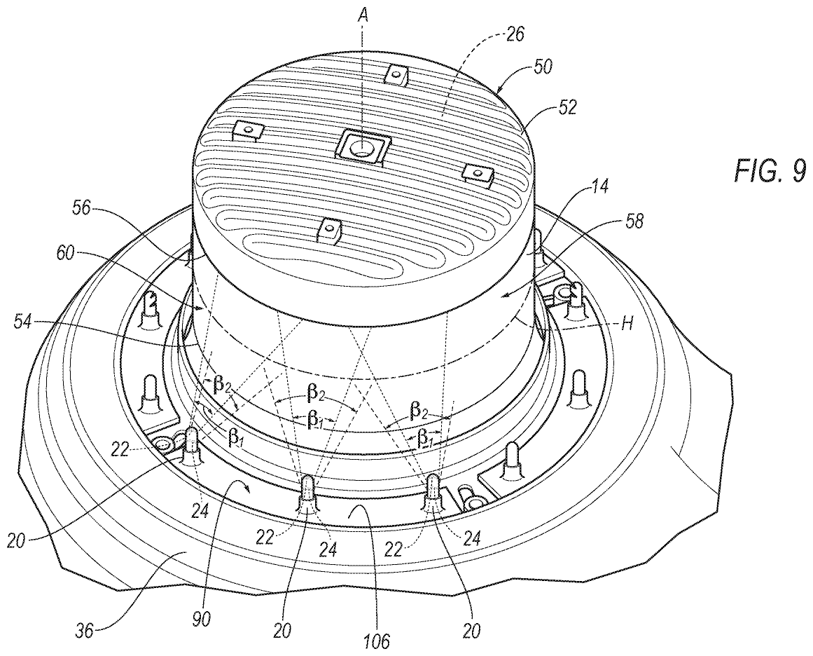

The sensor window 14 is cylindrical and defines the axis A, which is oriented substantially vertically. The sensor window 14 extends around the axis A. The sensor window 14 can extend fully around the axis A, i.e., 360°, or partially around the axis A. The sensor window 14 extends along the axis A from a bottom edge 54 to a top edge 56. The bottom edge 54 contacts the sensor-housing bottom 48, and the top edge 56 contacts the sensor-housing top 52. The sensor window 14 can be divided into a first half 58 and a second half 60, as shown in FIG. 9. The first half 58 and the second half 60 encompass all of the sensor window 14 and are nonoverlapping. The first half 58 is an upper half and extends, e.g., along the axis A, from a horizontal midline H of the sensor window 14 to the top edge 56, i.e., the sensor-housing top 52. The second half 60 is a lower half and extends, e.g., along the axis A, from the horizontal midline H to the bottom edge 54, i.e., the sensor-housing bottom 48. The first half 58 is farther from the nozzles 20 along the axis A than the second half 60.

With continued reference to FIG. 3, the sensor window 14 is positioned above the tubular segments 16, e.g., the bottom edge 54 of the sensor window 14 is above the tubular segments 16. The outer diameter of the sensor window 14 may be the same as the outer diameters of the sensor-housing top 52 and/or the sensor-housing bottom 48; in other words, the sensor window 14 may be flush or substantially flush with the sensor-housing top 52 and/or the sensor-housing bottom 48. “Substantially flush” means a seam between the sensor window 14 and the sensor-housing top 52 or sensor-housing bottom 48 does not cause turbulence in air flowing along the sensor window 14. At least some of the sensor window 14 is transparent with respect to whatever medium the sensor 26 is capable of detecting. For example, if the sensor 26 is a LIDAR device, then the sensor window 14 is transparent with respect to visible light at the wavelengths generated by the sensor 26.

The tubular segments 16 are fixed relative to the sensor window 14. For example, the tubular segments 16 can be mounted to the housing 34, e.g., bolted to the housing lower piece 38, to which the sensor housing 50 including the sensor window 14 is mounted. The tubular segments 16 can be directly attached to each other, or the tubular segments 16 can be attached to each other indirectly via the housing 34, e.g., the housing lower piece 38.

Each tubular segment 16 is elongated circumferentially around the axis A. The tubular segments 16 include at least three tubular segments 16; for example, as shown in the Figures, the tubular segments 16 include four tubular segments 16. Each tubular segment 16 can have substantially the same circumferential elongation around the axis A, e.g., 90°. The tubular segments 16 collectively form a ring 18 substantially centered around the axis A. The circumferential elongation of the tubular segments 16 can sum to 360°, e.g., four tubular segments 16 of 90°.

With reference to FIG. 4, an air cleaning system 62 includes a compressor 64, a filter 66, a chamber 68, and air nozzles 70. The compressor 64, the filter 66, and the air nozzles 70 are fluidly connected to each other (i.e., fluid can flow from one to the other) in sequence through the chamber 68.

The compressor 64 increases the pressure of a gas by, e.g., forcing additional gas into a constant volume. The compressor 64 may be any suitable type of compressor, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; or any other suitable type.

The filter 66 removes solid particulates such as dust, pollen, mold, dust, and bacteria from air flowing through the filter 66. The filter 66 may be any suitable type of filter, e.g., paper, foam, cotton, stainless steel, oil bath, etc.

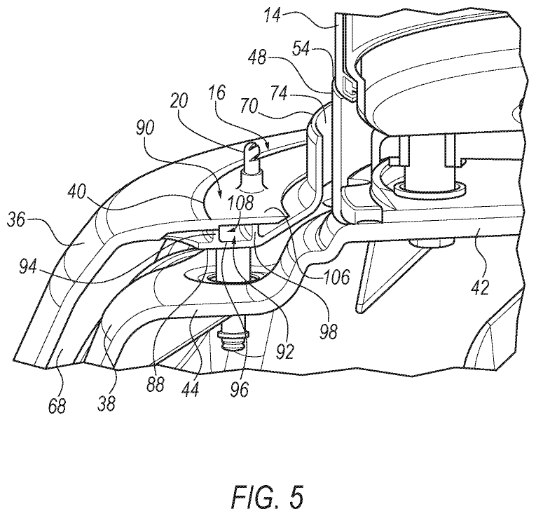

With reference to FIGS. 2 and 5, the housing upper piece 36 and the housing lower piece 38 form the chamber 68 by enclosing a space between the housing upper piece 36 and the housing lower piece 38. The compressor 64 can be positioned to pressurize the chamber 68, i.e., positioned to draw in air from outside the housing 34 and output air into the chamber 68.

The air nozzles 70 are positioned to receive pressurized air from the chamber 68 and discharge that air across the sensor window 14. The air nozzles 70 are oriented to discharge parallel to the axis A across the sensor window 14 from below the sensor window 14. The air nozzles 70 are formed of the sensor housing 50 and the tubular segments 16, specifically of the sensor-housing bottom 48 of the sensor housing 50 and of air-nozzle surfaces 72 of the tubular segment 16. Each tubular segment 16 includes one air-nozzle surface 72. The air-nozzle surfaces 72 are curved plates of substantially constant thickness. Each air-nozzle surface 72 extends vertically parallel to the axis A and circumferentially around the axis A at a substantially constant radius from the axis A. The direction of the thickness is orthogonal to the vertical and circumferential directions of extension of the air-nozzle surface 72. Pressurized air from the chamber 68 is directed vertically upward through a gap 74 formed between the sensor-housing bottom 48 and the air-nozzle surfaces 72.

Returning to FIG. 4, a liquid cleaning system 76 of the vehicle 10 includes a reservoir 78, a first pump 80, a second pump 82, liquid supply lines 84, valves 86, the tubular segments 16, and the nozzles 20. The reservoir 78 and the pumps 80, 82 are fluidly connected (i.e., fluid can flow from one to the other) to each valve 86, to each tubular segment 16, and thus to the nozzles 20. The liquid cleaning system 76 distributes washer fluid stored in the reservoir 78 to the nozzles 20. “Washer fluid” refers to any liquid stored in the reservoir 78 for cleaning. The washer fluid may include solvents, detergents, diluents such as water, etc.

The reservoir 78 may be a tank fillable with liquid, e.g., washer fluid for window cleaning. The reservoir 78 may be disposed in a front of the vehicle 10, specifically, in an engine compartment forward of a passenger cabin. Alternatively, the reservoir 78 may be disposed in the housing 34, e.g., in the chamber 68 or below the housing lower piece 38. The reservoir 78 may store the washer fluid only for supplying the sensor apparatus 12 or also for other purposes, such as supply to the windshield.

The pumps 80, 82 force the washer fluid through the liquid supply lines 84 to the valves 86 and then to the nozzles 20 with sufficient pressure that the washer fluid sprays from the nozzles 20. The pumps 80, 82 are fluidly connected to the reservoir 78. The pumps 80, 82 may be attached to or disposed in the reservoir 78. For example, the first pump 80 can be located in the reservoir 78, and the second pump 82 can be spaced from the reservoir 78. The pumps 80, 82 are arranged in series to supply washer fluid from the reservoir 78 to the valves 86 and then to the tubular segments 16. In other words, one of the pumps 80, 82 discharges fluid to the other of the pumps 80, 82, which in turn discharges the received fluid. Arranging the pumps 80, 82 in series can provide a greater pressure rise than other arrangements of the pumps 80, 82, e.g., in parallel.

The liquid supply lines 84 can extend from the first pump 80 to the second pump 82, from the second pump 82 to the valves 86, and from the valves 86 to the tubular segments 16. A separate liquid supply line 84 extends from each valve 86 to the respective tubular segment 16. The liquid supply lines 84 may be, e.g., flexible tubes.

The valves 86 are independently actuatable to open and close, to permit the washer fluid to flow through or to block the washer fluid; i.e., each valve 86 can be opened or closed without changing the status of the other valves 86. Each valve 86 is positioned to permit or block flow from the reservoir 78 to a respective one of the tubular segments 16. The valves 86 may be any suitable type of valve, e.g., ball valve, butterfly valve, choke valve, gate valve, globe valve, etc.

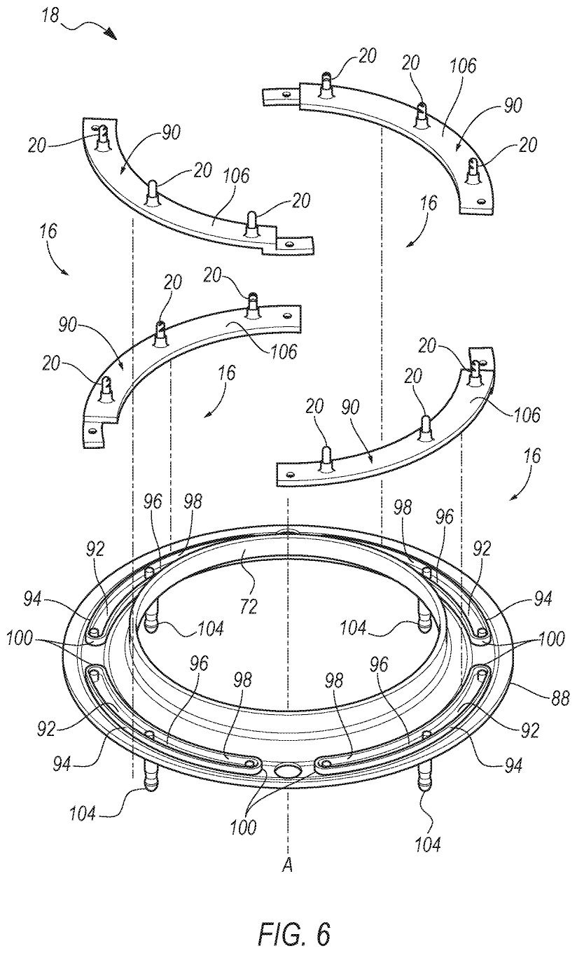

With reference to FIG. 6, each tubular segment 16 includes a lower piece 88 and an upper piece 90. Each lower piece 88 defines a channel 92 extending circumferentially around the axis A with the respective tubular segment 16. Specifically, each channel 92 has a substantially constant cross-section along an arc extending circumferentially around the axis A. The cross-section of each channel 92 includes a radially outer side wall 94, a floor 96, and a radially inner side wall 98, as shown in FIG. 5. The floor 96 extends horizontally, the radially outer side wall 94 extends vertically from a radially outer edge of the floor 96, and the radially inner side wall 98 extends vertically from a radially inner edge of the floor 96. Each lower piece 88 includes two end walls 100. Each channel 92 extends circumferentially around the axis A from one end wall 100 of that lower piece 88 to the other end wall 100 of that lower piece 88. Each lower piece 88 includes one of the air-nozzle surfaces 72. The air-nozzle surfaces 72 are each disposed radially inward relative to the axis A from the channel 92.

Each lower piece 88 includes an inlet 104. The reservoir 78 is fluidly coupled to each tubular segment 16 via the respective inlet 104. The inlets 104 extend downward from the respective lower pieces 88. Each inlet 104 may be disposed approximately halfway along the circumferential elongation of the respective lower piece 88; e.g., if the lower piece 88 has a circumferential elongation of 90°, the inlet 104 is approximately 45° from either end of the lower piece 88.

The lower pieces 88 may collectively be monolithic. In other words, the lower pieces 88 may collectively be a single-piece unit, i.e., a continuous piece of material without any fasteners, joints, welding, adhesives, etc., fixing multiple lower pieces 88 to each other. For example, the lower pieces 88 may be molded as a single piece, as shown in FIG. 6. As another example, the lower pieces 88 may be separately formed and subsequently attached together by, e.g., fasteners, welding, etc.

With continued reference to FIG. 6, each upper piece 90 of the respective tubular segment 16 encloses the respective channel 92 of the lower piece 88 of that tubular segment 16. Each upper piece 90 includes a base 106 extending circumferentially around the axis A with the channel 92 from one end wall 100 to the other end wall 100 of the respective lower piece 88, and each base 106 extends radially inward from the radially outer side wall 94 across the radially inner side wall 98 of the respective lower piece 88 (as shown in FIG. 5). The upper pieces 90 include the nozzles 20 supported by the respective base 106.

Each upper piece 90 is monolithic. In other words, each upper piece 90 is a single-piece unit, i.e., a continuous piece of material without fasteners, joints, welding, adhesives, etc. fixing multiple pieces to each other. For example, each upper piece 90 may be molded as a single piece. Each upper piece 90 includes a plurality of nozzles 20 and the base 106, so the base 106 and the nozzles 20 for each upper piece 90 are together a single piece, as shown in FIG. 6.

Returning to FIG. 5, each tubular segment 16 includes a cavity 108 enclosed by the upper piece 90 and the channel 92 and end walls 100 of the lower piece 88. Each tubular segment 16 is fluidly isolated from the other tubular segments 16. In other words, the cavities 108 of the tubular segments 16 are fluidly isolated from each other; i.e., the cavities 108 are arranged such that fluid cannot flow from one to the other. The cavities 108 are sealed other than the nozzles 20 and inlets 104.

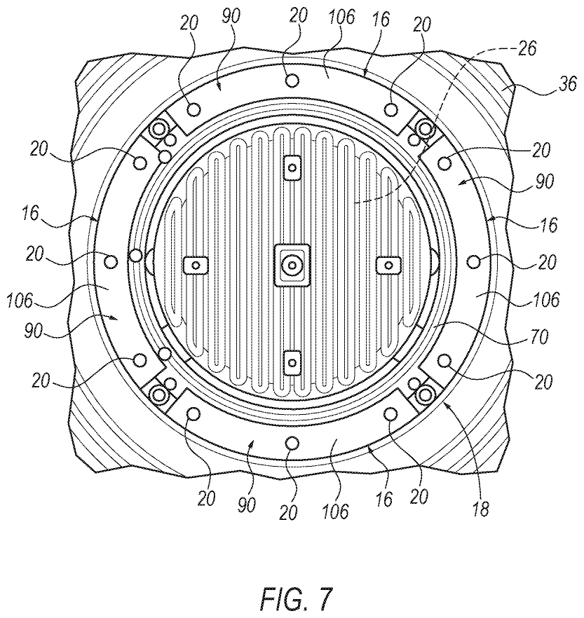

With reference to FIG. 7, each tubular segment 16 includes a plurality of nozzles 20 arranged around the ring 18 formed by the tubular segments 16. The nozzles 20 may be substantially evenly spaced around the ring 18, i.e., a distance from each nozzle 20 to the adjacent nozzle 20 is substantially the same. The plurality of nozzles 20 can include twelve nozzles 20. The plurality of nozzles 20 can be evenly divided among the tubular segments 16, e.g., with four tubular segments 16, each tubular segment 16 includes three nozzles 20.

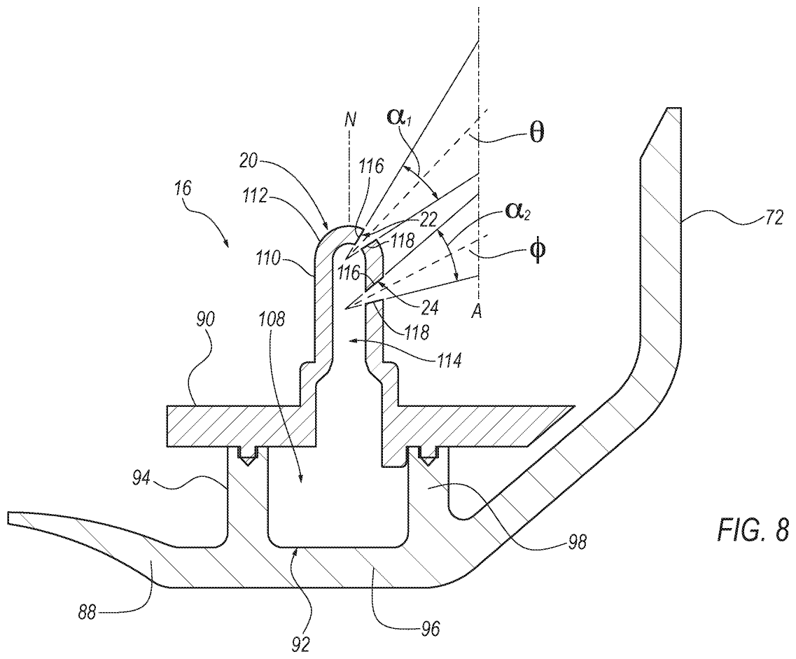

With reference to FIG. 8, the nozzles 20 are liquid nozzles. Each nozzle 20 defines a nozzle axis N extending parallel to the axis A. Each nozzle 20 includes a wall 110 extending along the nozzle axis N from the base 106 of the upper piece 90 to a top 112 spaced from the base 106 of the upper piece 90. For example, the wall 110 may be elongated along the nozzle axis N, i.e., the longest dimension of the wall 110 may be along the nozzle axis N. The wall 110 extends annularly, i.e., in an endless ring, about the nozzle axis N. The top 112 may have a hemispherical shape. The top 112 of the nozzle 20 may be spaced from the bottom edge 54, i.e., the sensor-housing bottom 48, along the axis A. That is, the nozzles 20 may be below the sensor window 14.

The wall 110 defines a nozzle cavity 114 extending circumferentially about the nozzle axis N from the bottom of the wall 110 to the top of the wall 110. The nozzle cavity 114 may be elongated along the nozzle axis N, i.e., the longest dimension of the nozzle cavity 114 may be along the nozzle axis N. The nozzle cavity 114 is in fluid communication with the cavity 108 of the tubular segment 16.

With continued reference to FIG. 8, each nozzle 20 includes a first opening 22 and a second opening 24. The first and second openings 22, 24 are spaced from each other along the nozzle axis N, i.e., vertically. The second opening 24 is disposed between the base 106 of the upper piece 90 and the first opening 22. The first opening 22 may, for example, be disposed on the top 112. As another example, the first opening 22 may be disposed between the second opening 24 and the top 112.

The first and second openings 22, 24 are aligned circumferentially around the nozzle axis N. That is, the first and second openings 22, 24 are aimed in the same radial direction relative to the axis A. The first and second openings 22, 24 each direct fluid exiting the respective opening 22, 24 toward the sensor window 14, radially inward toward the axis A. The first opening 22 and the second opening 24 each extend through the nozzle 20 to the nozzle cavity 114. The first and second openings 22, 24 are concurrently in fluid communication with the nozzle cavity 114. That is, fluid flows through each of the openings 22, 24 simultaneously.

With reference to FIGS. 8 and 9, the first and second openings 22, 24 are shaped to emit a spray pattern extending along sensor window 14. The spray pattern of the first opening 22 may, for example, extend along the first half 58 of the sensor window 14 to the second half 60 of the sensor window 14, e.g., from the top edge 56 to the horizontal midline H. The spray pattern of the second opening 24 may, for example, extend along the second half 60 of the sensor window 14 to the first half 58 of the sensor window 14, e.g., from the horizontal midline H to the bottom edge 54.

The spray patterns of each of the first and second openings 22, 24 have a deflection angle α₁, α₂ as shown in FIG. 8, and a spray angle β₁, β₂ as shown in FIG. 9. The spray angle β₁, β₂ is an angular width of the spray measured circumferentially around the nozzle axis N. The spray angle β₂ of the second opening 24 is different than the spray angle β₁ of the first opening 22. For example, the spray angle β₂ of the second opening 24 may be larger than the spray angle β₁ of the first opening 22, e.g., to provide coverage of the sensor window 14 that is closer to the second opening 24 than to the first opening 22.

The deflection angle α₁, α₂ is an angular thickness measured perpendicular to the spray angle β₁, β₂, e.g., axially along the nozzle axis N. The deflection angle α₁ for the first opening 22 may be the same as, or different than, the deflection angle α₂ for the second opening 24. The deflection angle α₁ for the first opening 22 covers the first half 58 of the sensor window 14, and the deflection angle α₂ for the second opening 24 covers the second half 60 of the sensor window 14.

Returning to FIG. 8, the first and second openings 22, 24 each may include an upper surface 116 and a lower surface 118 extending transverse to the upper surface 116. The upper surfaces 116 and the lower surfaces 118 each extend through the wall 110 to the nozzle cavity 114. The upper surfaces 116 of the first and second openings 22, 24 extend oblique, i.e., neither parallel nor perpendicular, to the axis A. The upper surfaces 116 of the first openings 22 each may extend transverse to the respective lower surfaces 118 of the respective second openings 24. The upper surface 116 and the lower surface 118 of each first opening 22 may define the spray pattern for that first opening 22, and the upper surface 116 and the lower surface 118 of each second opening 24 may define the spray pattern for that second opening 24. That is, fluid exiting one of the openings 22, 24 spreads into the spray pattern defined by the respective upper and lower surfaces 116, 118. The spray pattern may be, e.g., a full cone pattern. A full cone pattern produces a cone-shaped spray pattern with a vertex at a nozzle opening and a round, e.g., circular, elliptical, etc., cross-section orthogonal to the direction of discharge.

With continued reference to FIG. 8, the openings 22, 24 each have a direction of discharge directed along a center of the spray pattern, i.e., bisecting the spray angle β₁, β₂ and bisecting the deflection angle α₁, α₂. The direction of discharge of each first opening 22 is in a radially inward and axial direction with respect to the axis A, i.e., a direction that is toward the axis A and along the axis A, forming the first angle θ with the axis A. The direction of discharge of each second opening 24 is in a radially inward and axial direction forming the second angle φ with the axis A. The second angle φ is different than the first angle θ. For example, the first angle θ may be defined such that the fluid exiting the first openings 22 is directed to the first half 58 of the sensor window 14, i.e., the directions of discharge of the first openings 22 intersect the first half 58 of the sensor window 14, and the second angle φ may be defined such that fluid exiting the second openings 24 is directed to the second half 60 of the sensor window 14, i.e., the directions of discharge of the second openings 24 intersect the second half 60 of the window. The upper and lower surfaces 116, 118 of each first opening 22 define the first angle θ with the axis A, and the upper and lower surfaces 116, 118 of each second opening 24 define the second angle φ with the axis A.

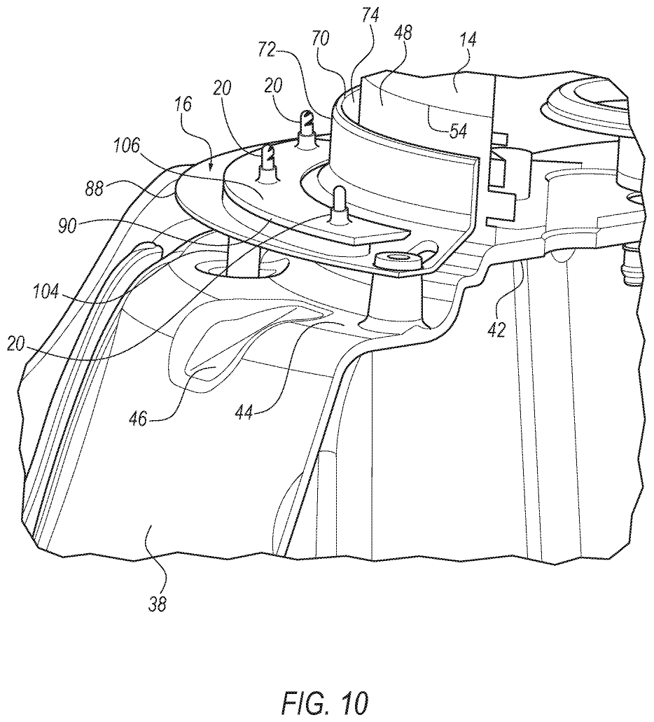

With reference to FIG. 10, the housing lower piece 38 includes a supporting panel 44 positioned directly below the tubular segments 16. The supporting panel 44 extends radially outward from the bracket 42. The supporting panel 44 is generally horizontal. The housing lower piece 38 includes a drainage channel 46. The drainage channel 46 extends into the supporting panel 44, i.e., extends radially inward from an outer circumference of the supporting panel 44, and the drainage channel 46 slopes downward in a radially outward direction. The drainage channel 46 can help drain fluid that flows through the gap 74 into the chamber 68.

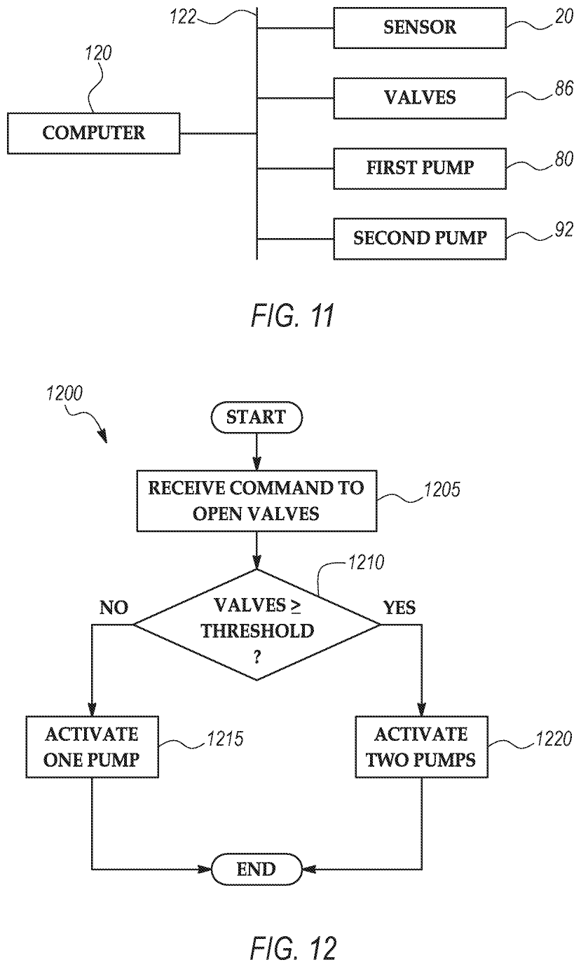

With reference to FIG. 11, the vehicle 10 includes a computer 120. The computer 120 is a microprocessor-based computing device, e.g., an electronic controller or the like. The computer 120 includes a processor, a memory, etc. The memory of the computer 120 includes media for storing instructions executable by the processor as well as for electronically storing data and/or databases.

The computer 120 may transmit and receive data through a communications network 122 such as a controller area network (CAN) bus, Ethernet, WiFi, Local Interconnect Network (LIN), onboard diagnostics connector (OBD-II), and/or by any other wired or wireless communications network. The computer 120 may be communicatively coupled to the sensor 26, the valves 86, the pumps 80, 82, and other components via the communications network 122.

FIG. 12 is a process flow diagram illustrating an exemplary process 1200 for controlling the sensor apparatus 12. The memory of the computer 120 stores executable instructions for performing the steps of the process 1200. As a general overview of the process 1200, the computer 120 receives a command to clean a portion of the sensor window 14 that includes a number of the valves 86 that will be open, and the computer 120 selects whether to activate one of the pumps 80, 82 or both pumps 80, 82 based on whether the number of open valves 86 is at least a threshold value.

The process 1200 begins in a block 1205, in which the computer 120 receives a command to clean the sensor window 14. The command will include which of the valves 86 will be open, and the computer 120 can count the number of the valves 86 that will be open. For example, the computer 120 may issue a command to clean an obstructed portion of the sensor window 14 that is centered above one of the tubular segments 16 that includes opening the valve 86 leading to that tubular segment 16 and leaving the rest of the valves 86 closed; in this case, one valve 86 is open. For another example, the computer 120 may issue a command to clean an obstructed portion of the sensor window 14 that is directly above where two of the tubular segments 16 meet and that includes opening the valves 86 leading to those two tubular segments 16 and leaving the other two valves 86 closed; in this case, two valves 86 are open. For another example, the computer 120 may issue a command to clean the entirety of the sensor window 14 that includes opening all the valves 86; in this case, four valves 86 are open. For another example, the computer 120 may issue a command to clean all of the sensor window 14 that is at least partially forward facing; in this case, three valves 86 can be open.

Next, in a decision block 1210, the computer 120 determines whether the number of valves 86 that are open is at or above a threshold, or whether the number is below the threshold. The threshold can be chosen based on the pressure that the pumps 80, 82 are able to deliver when different numbers of valves 86 are open. For example, if one of the pumps 80, 82 is capable of supplying sufficient pressure to clean the sensor window 14 for up to six nozzles 20, then the threshold is three valves 86. If the number of open valves 86 is below the threshold, e.g., is one or two when the threshold is three, the process 1200 proceeds to a block 1215. If the number of open valves 86 is at or above the threshold, e.g., is three or four when the threshold is three, the process 1200 proceeds to a block 1220.

In the block 1215, the computer 120 activates one of the two pumps 80, 82 e.g., the first pump 80, while maintaining the other pump 80, 82, e.g., the second pump 82, as inactive. Activating one of the pumps 80, 82 is coordinated with opening the selected valve or valves 86, e.g., is performed substantially simultaneously. The first pump 80 can be activated for a preset duration and then deactivated. After the block 1215, the process 1200 ends.

In the block 1220, the computer 120 activates both of the two pumps 80, 82.

Activating the pumps 80, 82 is coordinated with opening the selected valve or valves 86, e.g., is performed substantially simultaneously. The pumps 80, 82 can be activated for a preset duration and then deactivated. After the block 1220, the process 1200 ends.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. “Substantially” as used herein means that a dimension, time duration, shape, or other adjective may vary slightly from what is described due to physical imperfections, power interruptions, variations in machining or other manufacturing, etc. Many modifications and variations of the present disclosure are possible in light of the above teachings, and the disclosure may be practiced otherwise than as specifically described.

What is claimed is:

1. A sensor apparatus comprising:
a cylindrical sensor window defining an axis;
a plurality of at least three tubular segments fixed relative to the sensor window, each tubular segment being elongated circumferentially relative to the axis;
wherein the tubular segments collectively form a ring substantially centered around the axis;
each tubular segment includes a plurality of nozzles, each nozzle including a first opening and a second opening;
each of the first openings has a direction of discharge in a radially inward and axial direction forming a first angle with the axis; and
each of the second openings has a direction of discharge in a radially inward and axial direction forming a second angle with the axis, the second angle being different than the first angle.

2. The sensor apparatus of claim 1, wherein the nozzles are elongated along the axis, and the first opening is spaced from the second opening along the axis.

3. The sensor apparatus of claim 1, wherein the plurality of nozzles are substantially evenly spaced around the ring.

4. The sensor apparatus of claim 1, wherein the first and second openings are shaped to spray fluid in a full cone pattern.

5. The sensor apparatus of claim 1, wherein each nozzle defines a nozzle axis extending parallel to the axis, and the first and second openings are aligned circumferentially around the nozzle axis.

6. The sensor apparatus of claim 1, wherein each nozzle includes a wall defining a nozzle cavity, and the first and second openings each include an upper surface extending through the wall to the nozzle cavity and a lower surface extending transverse to the upper surface and through the wall to the nozzle cavity.

7. The sensor apparatus of claim 6, wherein the upper surface of each first opening is oblique to the axis, and the upper surface of each second opening is oblique to the axis.

8. The sensor apparatus of claim 6, wherein the upper and lower surfaces of each first opening define the first angle with the axis, and the upper and lower surfaces of each second opening define the second angle with the axis.

9. The sensor apparatus of claim 6, wherein the upper surface of each first opening extends transverse to the respective lower surface of the respective second opening.

10. The sensor apparatus of claim 6, wherein the first and second openings are concurrently in fluid communication with the nozzle cavity.

11. The sensor apparatus of claim 1, wherein the sensor window includes a first half and a second half, the first half and the second half of the sensor window encompass all of the sensor window and are nonoverlapping, the first half is farther from the nozzles along the axis than the second half, the direction of discharge of the first opening intersects the first half of the sensor window, and the direction of discharge of the second opening intersects the second half of the sensor window.

12. The sensor apparatus of claim 11, wherein the first opening is shaped to emit a spray pattern extending along the first half of the sensor window to the second half of the sensor window, and the second opening is shaped to emit a spray pattern extending along the second half of the sensor window to the first half of the sensor window.

13. The sensor apparatus of claim 1, wherein each nozzle defines a nozzle axis extending parallel to the axis, the first and second openings are each shaped to emit a spray pattern having a spray angle measured circumferentially about the respective nozzle axis, and the spray angle of the second opening is different than the spray angle of the first opening.

14. The sensor apparatus of claim 1, wherein each tubular segment is fluidly isolated from the other tubular segments.

15. The sensor apparatus of claim 14, further comprising a reservoir fluidly coupled to each tubular segment, and a plurality of valves, wherein each valve is actuatable to permit or block flow from the reservoir to a respective one of the tubular segments.

16. The sensor apparatus of claim 1, wherein each tubular segment includes a lower piece and an upper piece, each lower piece defines a channel extending circumferentially around the axis, and each upper piece encloses the channel.

17. The sensor apparatus of claim 16, wherein the upper pieces include the nozzles.

18. The sensor apparatus of claim 17, wherein each upper piece is monolithic.

19. The sensor apparatus of claim 16, wherein the lower pieces each include an inlet.

20. The sensor apparatus of claim 16, wherein the lower pieces are collectively a single piece that is monolithic.
